(19) United States
(12) Patent Application Publication
(10) Pub. No.: US 2005/0067880 A1
(43) Pub. Date: Mar. 31, 2005

(54) Free spinning vehicle wheel cover

(76) Inventors: Kirk A. Buhler, Corona, CA (US); George Vernon Buhler, Fountain Valley, CA (US)

Correspondence Address: BUHLER ASSOCIATES;BUHLER, KIRK A., 2687 SCENIC CREST LANE, CORONA, CA, 92881, US

(21) Appl. No.: 10/672,645

(22) Filed: Sep. 26, 2003

(51) Int. Cl. B60B 7/06

(52) U.S. Cl. 301/37.35

(57) ABSTRACT

A removable spinning hubcap that provides the appearance of the rim turning when the vehicle is not in motion. The invention discloses inner and outer members that are connected by a bearing. The inner member can be connected to an existing or custom tire rim. When the vehicle is in motion the turning of the inner rim exerts rotational motion to the inner member and then turns the outer member. Bearings are provided between the two members that allow the outer member to spin freely from the rotational inertial after the inner member changes rotational speed.

### FIELD OF THE INVENTION

The present invention relates to wheel covers or hubcaps that are connected to an existing vehicle wheel rim. More specifically the wheel cover consists of an inner member that attaches to the existing wheel, and an outer member that is connected to the inner member by way of a bearing that allows the two members to turn independently.

### BACKGROUND OF THE INVENTION

Many vehicles or cars today have covers or hubcaps that are placed over the rim of the metal wheel that supports tire. The purpose of the cover is to provide a cosmetic appearance that is often more attractive than the metal rim that supports the car and tire. The wheel cover also provides a secondary benefit of keeping some dirt or debris that may be generated from the brakes or the road off the outer surface of the wheel cover. A number of manufactures of tire rims have made rims where an outer rim spins independent of the rim. The benefit of this design is that the rotation of the tire turning as the vehicle moves on a road, some inertia from the rim turn the outer rim. When the rim mounted to the tire stops turning the outer rim continues to turn for some period of time based upon the efficiency of the bearings and the inertia stored in the outer rim. The result of this design provides the appearance of motion from the tires after the vehicle comes to a stop. This type of design requires the removal of the rims that came with the car, and replacing the rims with completely different rims with an outer rim that provides this effect. The ideal design would allow for a removable hubcap or cover having an inner and an outer member where the inner member could be bolted, screwed, retained, pressed or fit onto an existing rim. This type of design would provide a similar effect that can be obtained from replacing the entire rim.

U.S. Pat. No 5,464,276 issued to Ott discloses an attachment mechanism for connecting a wheel cover to the rim of a vehicle. The attachment mechanism is basically a spring device that hooks onto the rim of a wheel to hold the cover in place. The connection mechanism provides a means to retain the cover onto the wheel but does not provide for a secondary member that can turn independently from the holding mechanism.

U.S. Pat. Nos. 6,443,529 issued to Williams 6,120,104 issued to Okamoto, and 4,678,239 issued to Matsushita discloses a wheel cover with an inner and outer member. In these patents, the two members are connected by means of a bearing that allow the two members to turn independently of each other. The outer member is eccentric or weighted so the outer member stays in a semi-fixed orientation compared to the horizon. The purpose of the weighting or eccentric outer member is to allow the design slogan or message that is on the outer member to be at an orientation that when the wheels are turning the design slogan or message can be visible by seeming to be in a fixed orientation. While these patents discloses an inner and outer member that can turn independently from each other the outer member is intended to remain at a semi-fixed orientation with the horizon, and no inertia from the turning of the wheel is imparted onto the outer member.

A number of companies, notably Spinwheel, Oasis, and Omega manufacture vehicle rims with an outer member where the outer member turns independent from the rim that mounts the tire. These rims provide an outer member that spin independently from wheel, and a portion of the rotational inertial from the inner member is transferred to the outer member, but in this product the entire rim must be removes from the vehicle and replaced. This device does not provide for a cover or removable cover that provides the independent rotation, where some rotational inertia is transferred between the two members.

While these devices provide for a free spinning outer rim that is weighted to keep the outer rim at a upright orientation, mounting mechanism for the cover to a rim, and a replacement rim with an inner and outer surface, none of the disclosed devices provide the combination of a non-weighted free spinning inner and outer rim that can be connected to an existing tire rim.

### SUMMARY OF THE INVENTION

It is an object of the present invention to provide a wheel cover with an inner cover that attached to the wheel, and a free spinning outer cover. The inner and outer covers are connected with a bearing. The arrangement of the members provides for the inner and outer member to turn independently from each other and when the inner member is in rotation, some inertia from the rotating will cause the outer member to rotate. Once the inner member stops rotating the outer member will continue to rotate based upon the inertial stored in the outer member, the efficiency of the bearings and any air resistance. The invention is intended for use to provide the appearance that the wheel is rotating when the vehicle is stopped.

The inner member can attach to the existing rim by a number of methods, including magnets, springs, clips, and interferance fits. The bearings can be a variety of types including standard ball and roller bearings, graphite, bronze or plastic bearings, and individual ball bearings. The inner and outer member can be made from a variety of materials including metal, plastics, or any other type material that will provide sufficient structural support and acceptable results. The color and finish of the materials can be a variety of different types from shinny metal to dull plastic, the members may also be made from different colors so the two spinning parts provide different effects when they are turning.

Methods and apparatus are provided herein that provide for a number of different mounting configurations, bearing arrangements, inner and outer member designs. In addition to the previously mentioned variations, color, and material options are contemplated that allow for a broad range of embodiments.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is an exploded view of one embodiment of the invention.

FIG. 2 is a cross sectional view of one embodiment of the invention.

FIG. 3 is a cross sectional view of a second embodiment of the invention.

FIG. 4 is a cross sectional view of a third embodiment of the invention.

FIG. 5 is a detailed view of one mounting embodiment of the invention.

FIG. 6 is a detailed view of a second mounting embodiment of the invention.

### DETAILED DESCRIPTION

Referring now to the accompanying drawings, the features of the invention will now be explained and will show that the present invention provides an innovative technique for providing a free spinning vehicle wheel cover.

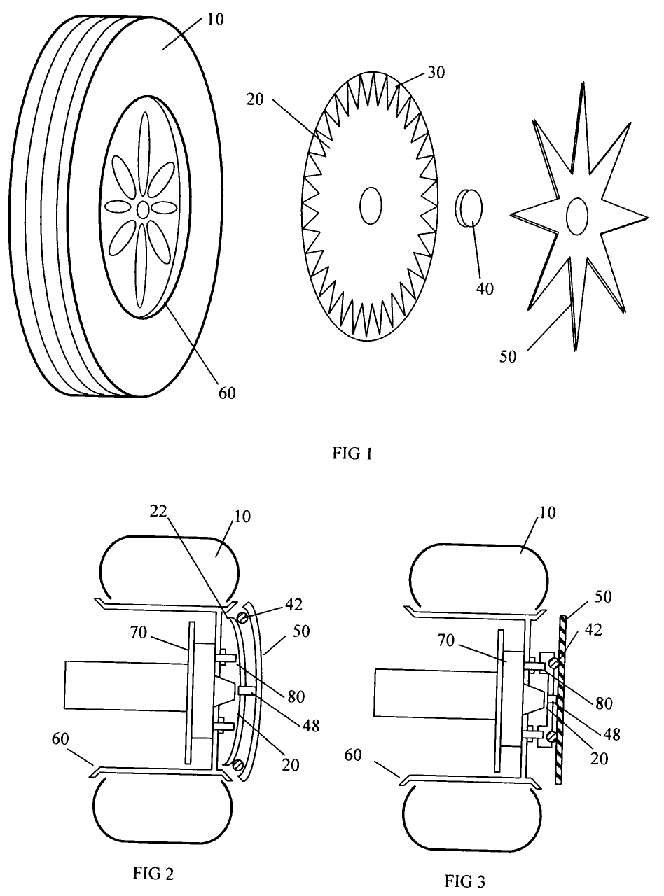

FIG. 1 is an exploded view of the invention mounted to the tire of a car, item 10. While the invention is ideally suited for mounting on a car tire, the invention can be used on any type wheel that spins. Some examples of other types of wheels may include trains, plane, busses, or any type of wheel that is supported with a bearing on one side, and the other side of the wheel is not supported by a complimentary bearing. The wheel shown is made of a flexible material such as rubber, but could be made from any type of material that can support the weight of the vehicle. This may also include a non-flexible material such as in the case of a train where the wheel is made of metal. The wheel is mounted, supported or suspended by a rim, item 60. The rim provides a number of functions including supporting the wheel, providing a connection between the vehicle and the tire, providing a sealing surface for the tire, and providing a mounting surface for the invention. The outer surface of the rim is usually depressed, and the depression provides a surface where tangs clips or compression members, item 30 can retain the inner member of the invention, item 20. The compression members can be configured in a number of methods from bent steel springs to a continuous member that is press fit into the existing tire rim. Regardless of the configuration of the retaining components or components, the purpose of the inner member is that the inner member is retained on the rim of the vehicle. The configuration or shape of the inner member can be a variety of shapes or designs. The range of the shapes or designs can range from a simple plate of flat, concave, or convex shape, to an intricate design that interacts with an outer member 50. The size of the inner member can also vary from a small diameter that just covers the inner area in the center of a car rim to a diameter that covers the entire rim of the wheel, or be even larger than the rim of the wheel and cover a portion of the tire. The shape of the inner member can range from round to triangular, square or can have holes or elongated members that extend from the center, edges, or from within the rim. The ornamental design of the inner member is not critical to the invention, but is critical to the aesthetic appearance of the finished product. The material for the inner member may be a variety of types including metal, plastics, fiberglass, rubber or any type of material that provides a connecting mechanism, and a surface the can be used as a bearing, or a bearing can be mounted within or onto. In the preferred embodiment, the inner member is made from metal. The inner member may be manufactured from multiple pieces that are molded together, bonded together or joined in some manner that make the inner member. The color of the inner member may be any color including a variety of colors. The color may also be metallic or reflective. The process of making the inner member can be molded, cast, stamped, drawn, machined or any manufacturing process that produces a part capable of retaining the inner member to the rim, and provide an integrated or attachable bearing. The inner member may contain a power-generating device that converts the rotation of the wheel into electricity that can be used to illuminate or flash lights connected to the invention. The power-generating device can store the energy in batteries that can prolong the rotation of the rim while the vehicle is stopped, or continue to illuminate lights when the vehicle is stopped

The retaining device 30 can be formed from a variety of components including metal clip, plastic clips, or rubber parts. The retaining mechanism may be one or more springs with hooks on the ends that engage in holes on the tire rim. The material used can be any type configuration that allows the inner member 20 to be retained in the rim 60. The retaining of the inner rim should be secure enough that the inner member should remain intact onto the rim of the tire under normal use of the vehicle. The engagement mechanism should also allow for removal of the inner member should the tire require repair or replacement. Various wheel cover retention mechanisms have been in use for this purpose of temporarily holding the cover onto the rim of a vehicle. Located within the inner member is a bearing 40.

The bearing 40 is shown located in the center of the inner member in FIG. 1. In FIG. 1, the bearing is shown as a separate component to the assembly, but the bearing could consist of individual ball bearings where the inner race is formed from the inner member, and the outer race is formed in the outer member, item 50. The bearing many be a single bronze, nylon, low friction bearing that allows the inner and outer member to spin independently from each other. In the preferred embodiment, the bearing is a separate component comprising of a roller bearing or ball bearing. Numerous companies manufacture bearings that are adequate for the application including Abbott, NSK, Torrington, SKF, NTN and others. Abbott manufactures bearing that are capable of being used in the design and more specifically bearing number ABEC 6201 has been used in prototypes. The use of a separate bearing requires that a mounting surface be formed or machined in the inner member that can retain and support the bearing. In the manufacturing process, the bearing is press fit into the inner member. The outer member 50 is then press fit onto the opposing race of the bearing. This arrangement allows the inner and outer members to turn independently from each other.

The outer member 50 is a decorative member that spins free from the inner member. When the car is in motion, the tire turns, as the tire turns the inner member is turned because it is attached to the rim and tire. As the inner member turns, the bearing turns, and a portion of the rotational energy is transferred to the outer member. It is a critical part of the invention that the outer member be balanced such that the outer member is concentric and not out of balance or eccentric so the outer member will continue to spin after the inner member comes to a stop. The rotational energy is stored as inertia in the outer member, and when the vehicle is at rest the outer member will continue to spin for a portion of time as the inertia spins the outer member until the frictional forces in the bearing and air resistance slows the outer member and eventually brings the outer member to a stop. The configuration or shape of the outer member can be a variety of shapes or designs. The range of the shapes or designs can range from a simple plate of flat, concave, or convex shape, to an intricate design that interacts with an inner member. The size of the inner member can also vary from a small diameter that just covers the inner area in the center of a car rim to a diameter that covers the entire rim of the wheel, or be even larger such that the rim of the wheel covers a portion of the tire. The shape of the outer member can range from round to triangular, square or can have holes or elongated members that extend from the center, edges, or from within the rim. The ornamental design of the outer member is not critical to the invention, but is critical to the aesthetic appearance of the finished product. The outer member may be made from a network or wires to provide the look of spokes. The material for the for the outer member may be a variety of types including metal, plastics, fiberglass, rubber or any type of material that provides a connecting mechanism, and a surface the can be used as a bearing, or a bearing can be mounted to. In the preferred embodiment, the outer member is made from metal.

The outer member may be manufactured from multiple pieces that are molded together, bonded together or joined in some manner that make a outer member. The color of the outer member may be any color including a variety of colors. The color may also be metallic or reflective. The process of making the inner member can be molded, cast, stamped, drawn, machined or any manufacturing process that produces a part capable of retaining the outer member to the bearing or bearing race. The outer member may contain a power-generating device that converts the rotation of the wheel into electricity that can be used to illuminate or flash lights connected to the invention.

Refer now to FIGS. 2, 3 and 4 that shows different configurations of mounting the invention onto a wheel of a car or similar vehicle. This figure shows the tire 10 mounted on the rim 60. The axle is shown with the brake rotor, item 70. The lug bolts that retain the rim 60 onto the axle of the car 70 are shown as item 80. The inner member of the invention is shown as item 20 with the compression fingers, item 22 on the inner member. The fingers press against the rim to 10 retain the inner member onto the rim of the wheel. The bearings are located in the outer portion of the rim of the wheel, item 42. The outer member 50 contains the opposing bearing race and allows the outer member to spin freely. In this configuration of the invention, the bearings comprise individual balls that are retained between the inner and outer members. Retainer 48 keeps the inner and outer members together.

FIG. 3 shows the tire 10 mounted on the rim 60. The axle is shown with the brake rotor, item 70. The lug bolts that retain the rim 60 onto the axle of the car 70 are shown as item 80. The inner member of the invention is shown as item 20 with the inner member mounted onto the lug bolts 80. FIG. 5 shows a detailed view of the mounting onto one of multiple lug bolts that retain the wheel onto the vehicle. Lug nut 85 is threaded onto the lung bold 80. The inner member 20 contains fingers 24, that are pressed onto the lug bolt to retain the inner member. FIG. 6 shows an alternative configuration of the mounting where the lug bolts 80 and lug nuts 85 are recessed in a machined rim, and the retaining fingers 26 are pressed into one of the recesses in the wheel rim. The bearings are located in the mid portion of the rim of the wheel, item 42. The outer member 50 contains the opposing bearing race and allows the outer member to free spin. In this configuration of the invention, the bearings comprise individual balls that are retained between the inner and outer members. Retainer 48 keeps the inner and outer members together.

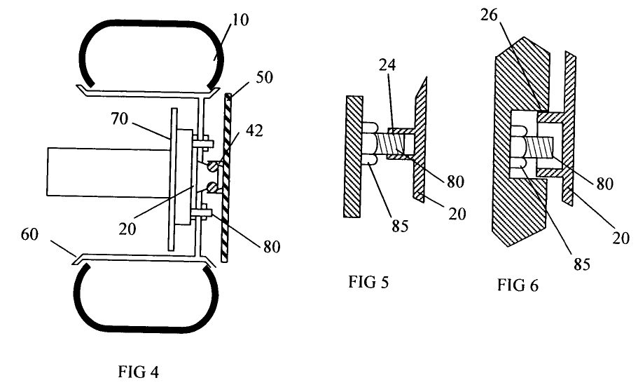

FIG. 4 shows the tire 10 mounted on the rim 60. The axle is shown with the brake rotor, item 70. The lug bolts that retain the rim 60 onto the axle of the car 70 are shown as item 80. The inner member of the invention is shown as item 20. In this embodiment, the inner member is bolted onto the rim 60, and held in place by the lug nuts. The bearings 42 are mounted onto the inner member 20, and the outer member 50 is connected to the outer race of the bearings. The outer member covers at least a portion of the rim, and may cover most of the rim. The outer member may be removable from the inner member, to allow removal of the tire from the car, or may include one or more holes, so the outer member can be rotated to provide access to the lug nuts. The outer member may also include a cover over an access hole to allow removal of the tire from the car. A second, third, or more outer covers may be incorporated that each spin independently or may be weighted or eccentric to provide rotation or fixed angle with the horizon.

In the embodiments shown the inner and outer covers are on the same centerline axis as the axle of the vehicle. Alternately, one or more outer covers can be placed off the axis of the centerline of the vehicle axle. This will provide multiple rotating members that can spin independently of the inner member.

Thus, specific embodiments and applications of methods of providing a freely spinning wheel cover have been disclosed. Its should be apparent, however, to those skilled in the art that many more modifications besides those described are possible without departing from the inventive concepts herein. For example, the inner member may be magnetically attached to the rim of the car, or the inner member may be snapped into holes on the tire rim for attachment. Another example is that the outer member may be made from a flexible material that changes shape based upon the rotational speed of the wheel and centrifugal forces placed upon it. The inventive subject matter, therefore, is not to be restricted except in the spirit of the appended claims.

1. A wheel cover for a vehicle comprising;
an inner member with attachment mechanism for connecting to a vehicle rim,
at least one outer member that is not eccentrically weighted,
a bearing mechanism that connects the inner member to the outer member to allow the members to turn independently from each other.

2. The attachment mechanism in claim 1 where the attachment mechanism consists of clips or springs.

3. The attachment mechanism in claim 1 where the attachment mechanism consists of one or more magnets.

4. The outer member of claim 1 where the outer member is made from a material consisting of metal, plastic, and rubber.

5. The bearing mechanism of claim 1 where the bearings are made from ball bearings, plastic bearings, and bronze bearings.

6. A third cover member connected with a bearing to the inner or outer member from claim 1.

7. The at least one outer member from claim 1 where the at least one outer member is located on or off axis from the axis of the inner member.

8. A wheel cover for a vehicle comprising;
an inner member with attachment mechanism for connecting to a vehicle rim,
a bearing mechanism connected to at least a part of the inner member and the bearing mechanism is connected to at least a part of an outer member where
the outer member can spin turn independent from the inner member, and,
at least a portion of the rotational inertia from the inner member turning is transferred to the outer member.

9. The attachment mechanism in claim 8 where the attachment mechanism consists of clips or springs.

10. The attachment mechanism in claim 8 where the attachment mechanism consists of one or more magnets.

11. The outer member of claim 8 where the outer member is made from a material consisting of metal, plastic, and rubber.

12. The bearing mechanism of claim 8 where the bearings are made from ball bearings, plastic bearings, and bronze bearings.

13. A third cover member connected with a bearing to the inner or outer member from claim 8.

14. The at least one outer member from claim 8 where the at least one outer member is located on or off axis from the axis of the inner member.

15. A method of manufacturing a wheel cover comprising of,
manufacturing an outer member that can attach to a vehicle rim,
manufacturing a concentric inner member,
connecting the inner and outer members with a bearing mechanism that allows the inner and outer member to spin independent of each other.

16. The outer member from claim 15 where the attachment mechanism consists of metal clips.

17. The outer member from claim 15 where the attachment mechanism consists of one or more magnets.

18. The outer member of claim 15 where the outer member is made from a material consisting of metal, plastic, and rubber.

19. The bearing mechanism of claim 15 where the bearings are made from ball bearings, plastic bearings, and bronze bearings.

20. The method from claim 15 further comprising attaching a third cover member to the inner or outer member with a bearing.
